(19) United States
(12) Patent Application Publication
(10) Pub. No.: US 2020/0317322 A1
(43) Pub. Date: Oct. 8, 2020

(54) EMERGENCY EXIT ASSEMBLY FOR AN AIRCRAFT

(71) Applicant: BOMBARDIER INC., Dorval (CA)

(72) Inventors: Tibor KOVARIK, Toronto (CA); Michael WORR, Pincourt (CA)

(73) Assignee: Bombardier Inc., Dorval, QC (CA)

(21) Appl. No.: 16/304,840

(22) PCT Filed: May 30, 2017
(86) PCT No.: PCT/IB2017/053184

§ 371 Date: Nov. 27, 2018

Related U.S. Application Data
(60) Provisional application No. 62/343,234, filed on May 31, 2016.

(51) Int. Cl. B64C 1/32; B64C 1/14

(52) U.S. Cl. CPC B64C 1/32; B64C 1/1484

(57) ABSTRACT

An emergency exit assembly for an aircraft, including a window frame, a window assembly having an outer surface abutting the inner surface of the window frame around its perimeter, and retaining elements spaced around the perimeter of the window assembly. The retaining elements are each connected to the window frame and bias the window assembly toward and against the inner surface of the window frame. Each retaining element has a force-release portion so that the window assembly can be disengaged from the window frame through release of the force-release portion. The force-release portion may be a frangible portion breakable upon application of the pulling force. A cable with one or more handle(s) may be connected to the retaining elements to apply the pulling force. A method of accessing an emergency exit of an aircraft is also discussed.

### CROSS-REFERENCE TO RELATED APPLICATIONS

This application claims priority from U.S. provisional application No. 62/343,234 filed May 31, 2016, the entire contents of which are incorporated by reference herein.

### TECHNICAL FIELD

The application relates generally to an emergency exit assembly for an aircraft and, more particularly, to such an emergency exit configured for use by trained crew members.

### BACKGROUND OF THE ART

Some existing mechanisms to disengage a window from a vehicle to provide for an emergency exit include relatively complex systems with levers and gear assemblies; such mechanisms may however be susceptible to damage and/or jamming, which in some cases may prevent the mechanism from being used when required. For some vehicles, it is also known to provide a window smaller than a window opening and connected to the frame by a seal extending radially around the window, with a feature embedded in the seal allowing to tear the seal so that the window may be detached from the frame; such window configurations are however not suitable to be used with a pressurized cabin.

### SUMMARY

In one aspect, there is provided an emergency exit assembly for an aircraft, the assembly comprising: a window frame having spaced inner and outer surfaces interconnected by an edge surface, the edge surface surrounding a window opening; a window assembly sealing the window opening and having an outer surface abutting the inner surface of the window frame around a perimeter of the window assembly; and a plurality of retaining elements spaced around the perimeter of the window assembly, the retaining elements each connected to the window frame and biasing the window assembly toward and against the inner surface of the window frame, each retaining element including a frangible portion so that the window assembly can be disengaged from the window frame through breaking of the frangible portion.

The emergency exit assembly may include any one or any combination of the following:
each of the retaining elements having first and second members connected to one another, the first member engaged to the window assembly and the second member connected to the window frame, the frangible portion being provided in the first member;
at least one cable connected to the first member of the retaining elements;
at least one handle attached to the at least one cable;
a single cable serially connected to the first member of the retaining elements;
the at least one cable forming a plurality of closed loops each engaged in a lug of the first member of a respective one of the retaining elements;
the first and second members being removably interconnected by a clamp preventing relative motion therebetween;
the frangible portion being located in proximity of the clamp;
the first member of each of the retaining elements including an outer flange engaged to the window assembly, a planar body extending radially inwardly and toward the window frame, and an inner flange extending from the planar body and connected to the second member, the body extending non-perpendicularly to the inner and outer flanges
the second member including a radial flange extending radially inwardly from the window frame and an additional inner flange extending perpendicularly to the radial flange and connected to the inner flange of the first member;
the frangible portion comprises a groove of reduced thickness compared to a remainder of the retaining element;
a seal extending around an edge of the window assembly along an inner surface of the window assembly and between the window assembly and the window frame, the retaining elements engaging the window assembly through contact with and compression of the seal;
an end cable portion extending from a first one of the retaining elements, a plurality of intermediate cable portions each extending between a respective pair of adjacent ones of the retaining elements, a first handle connected to the end cable portion and at least one additional handle each attached to a respective one of the intermediate cable portions;
an interior wall panel overlaying the plurality of retaining elements so as to hide the plurality of retaining elements from view, the interior wall panel having an opening aligned with a major part of the window assembly, the interior wall panel being removable.

In another aspect, there is provided an emergency exit assembly for an aircraft, the assembly comprising: a window frame having spaced inner and outer surfaces interconnected by an edge surface, the edge surface surrounding a window opening; a window assembly sealing the window opening and having an outer surface abutting the inner surface of the window frame around a perimeter of the window assembly; and a plurality of retaining elements spaced around the perimeter of the window assembly, each of the retaining elements engaged to the window assembly and connected to the window frame, the retaining elements biasing the window assembly toward and against the inner surface of the window frame, each of the retaining elements having a force-release portion so that the window assembly can be disengaged from the window frame through release of the force-release portion; wherein upon application of a predetermined pulling force on the force release portion, at least a portion of the retaining element engaged to the window assembly is detachable from the window frame.

The emergency exit assembly may include any one or any combination of the following:
each of the retaining elements having first and second members connected to one another, the first member engaged to the window assembly and the second member connected to the window frame, the force release portion including a frangible portion intermediate the window assembly and a connection of the first member with the second member, the frangible portion being breakable upon application of the predetermined pulling force on the first member;
a seal extending around an edge of the window assembly along an inner surface of the window assembly and between the window assembly and the window frame, the retaining elements engaging the window assembly through contact with and compression of the seal;
a cable serially connected to the retaining elements for application of the pulling force;
the at least one cable including an end cable portion extending from a first one of the retaining elements and a plurality of intermediate cable portions each extending between a respective pair of adjacent ones of the retaining elements, the assembly further comprising a first handle connected to the end cable portion and at least one additional handle each attached to a respective one of the intermediate cable portions;
each of the retaining elements including an outer flange engaged to the window assembly, a planar body extending radially inwardly and toward the window frame, and an inner flange extending from the planar body and connected to a member connected to the window frame, the body extending non-perpendicularly to the inner and outer flanges;
the inner flange being a first inner flange, the member including a radial flange extending radially inwardly from the window frame and a second inner flange extending perpendicularly to the radial flange and connected to the first inner flange.

In a further aspect, there is provided a method of accessing an emergency exit of an aircraft, the method comprising: breaking a plurality of retaining elements biasing a window assembly against an inner surface of a window frame, wherein breaking the retaining elements is performed by pulling at least one cable attached to the retaining elements; and displacing the window assembly inwardly in the aircraft to access a window opening previously obstructed by the window assembly, the window opening defining the emergency exit.

In a particular embodiment, pulling on the last least one cable includes sequentially pulling a plurality handles attached to a same cable, the handles spaced apart around a perimeter of the window assembly.

In a particular embodiment, the method may further comprise, before pulling the at least one cable, removing an interior wall panel overlaying the retaining elements and the at least one handle to expose the at least one handle.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an exemplary aircraft in which the emergency exit assembly of the present disclosure may be used;

FIG. 2 is a schematic tridimensional view of the emergency exit assembly in accordance with a particular embodiment, with an interior wall panel removed for improved clarity;

FIG. 3 is a schematic tridimensional view of a retaining element and cable of the emergency exit assembly of FIG. 2, in accordance with a particular embodiment;

FIG. 4 is a schematic cross-sectional view of the retaining element of FIG. 3 and surrounding portions of the window assembly and window frame; and

FIG. 5 is a schematic cross-sectional view of a retaining element and surrounding portions of the window assembly and window frame in accordance with an alternate embodiment.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION

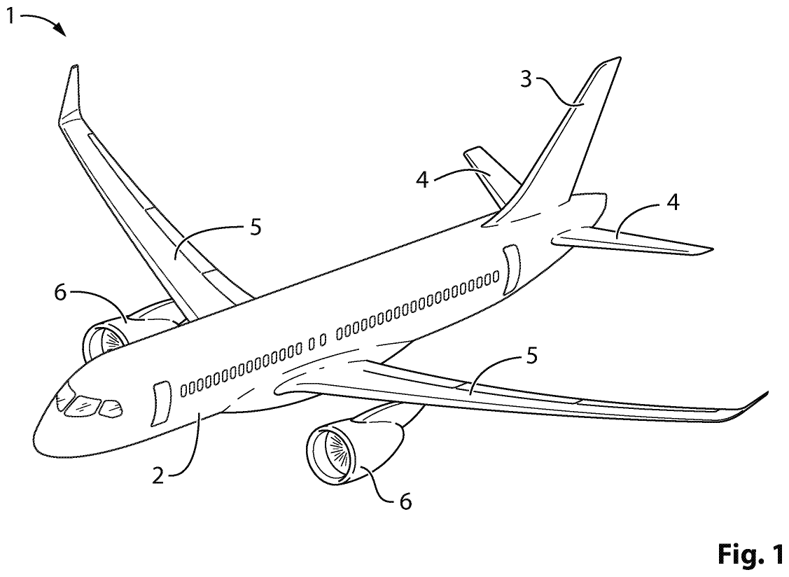

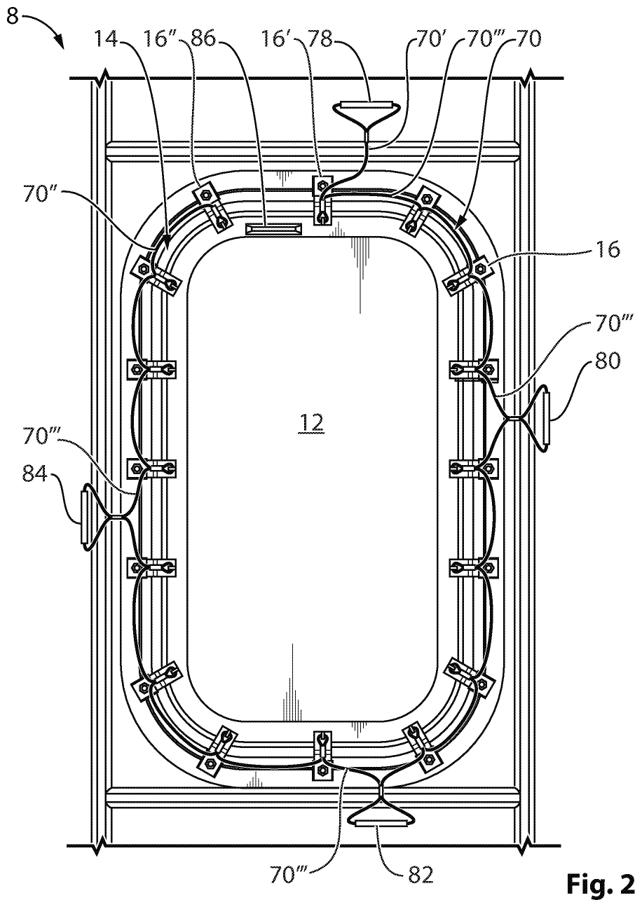

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft. The aircraft fuselage 2 includes a plurality of window openings 10 each sealingly engaged by a respective window assembly 12 (see FIG. 2), with the window assemblies being retained and configured so as to be able to maintain pressurization of the cabin in use.

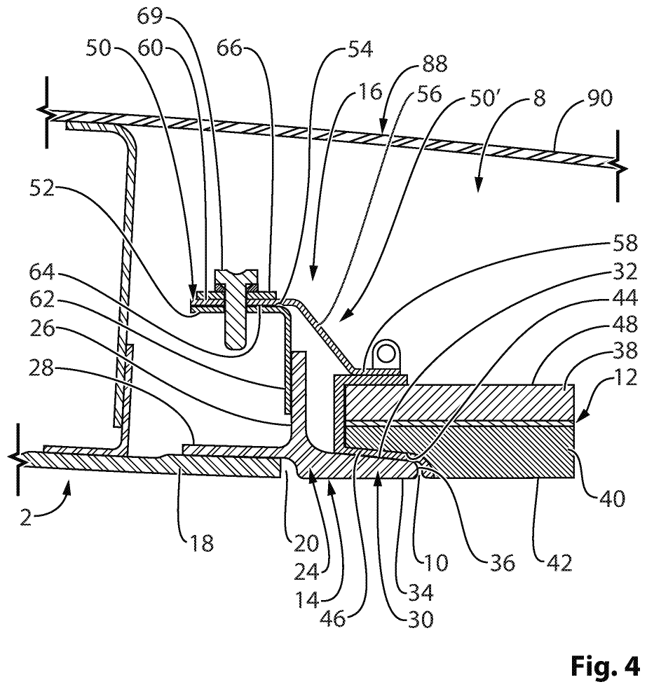

Referring to FIGS. 2 and 4, at least one of the window assemblies 12 forms part of an emergency exit assembly 8, which generally further includes an associated window frame 14 and retaining elements 16 interconnecting the window assembly 12 and window frame 14.

As can be best seen in FIG. 4, the outer skin 18 of the fuselage 2 has a hole 20 defined therethrough for engaging the window frame 14. The window frame 14 may have any suitable configuration. In the embodiment shown, the window frame 14 is connected to the fuselage skin 18 and extends within the hole 20 defined therethrough to extend around the perimeter of the hole 20 and frame the smaller window opening 10 within this hole 20. The window frame 14 has a T-shaped cross-section, with a base 24 generally extending along a direction defined by the fuselage skin 18 and a radial portion 26 extending radially inwardly from the base 24, for example perpendicularly or substantially perpendicularly thereto.

The base 24 defines two legs 28, 30 extending opposite one another from the radial portion 26. One of the legs 28 extends away from the window opening 10 and has an outer surface in contact with an inner surface of the fuselage skin 18 at the perimeter of the hole 20, and the other leg 30 protrudes in the hole 20. This protruding leg 30 has radially spaced inner and outer surfaces 32, 34 interconnected by an edge surface 36 which surrounds and defines a perimeter of the window opening 10.

It is understood that the terms “inward”, “inner” and related terms as used herein refer to a direction toward the interior of the aircraft 1, and that by contrast the terms “outwardly”, “outer” and related terms refer to an opposite direction toward the environment around the aircraft 1. Accordingly, the inner surface 32 of the window frame 14 is located inside the aircraft 1 and faces the interior of the cabin, while the outer surface 34 of the window frame 14 faces, and in a particular embodiment is exposed to, the surrounding environment.

Still referring to FIG. 4, the window assembly 12 is larger than the window opening 10 (e.g. the window assembly 12 has a greater height and width than the corresponding height and width of window opening 10). The window assembly 12 is located inwardly of the inner surface 32 of the window frame 14, and has an outer surface abutting the inner surface 32 of the protruding leg 30 of the window frame 14 around its perimeter; accordingly, the force created on the window assembly 12 by the pressurized air upon pressurization of the cabin pushes the window assembly 12 against this inner surface 32.

The window assembly 12 may have any suitable configuration. In the embodiment shown, the window assembly 12 includes an inner pane 38 and an outer pane 40. The outer surface 42 of the outer pane 40 has a recess 44 defined therein complementary to the protruding leg 30 of the window frame 14, and abuts the inner surface 32 of the protruding leg 30 within the recess 44, so that upon assembly the outer surface 34 of the protruding leg 30 and the outer surface 42 of the outer pane 40 are aligned or substantially aligned. A seal 46 is provided on the edges of the window panes 38, 40 around the perimeter of the window assembly 12, the seal 46 extending from the inner surface 48 of the inner pane 38 to the recess 44 in the outer surface 42 of the outer pane 40. In a particular embodiment, the seal 46 is engaged to the window panes 38, 40 through a snug fit, e.g. based on a predetermined amount of shrink around the perimeter.

As can be best seen in FIG. 2, the retaining elements 16 are spaced, for example regularly or substantially regularly spaced, around the perimeter of the window assembly 12. In the embodiment shown, sixteen (16) retaining elements 16 are provided; it is understood that alternately, any adequate number of retaining elements 16 may be used. The retaining elements 16 interconnect the window assembly 12 and the window frame 14, as further detailed below, and bias the window assembly 12 toward and against the inner surface 32 of the window frame 14. In the embodiment shown, the retaining elements 16 thus act as springs, producing a force compressing the seal 46 between the window assembly 12 and the window frame 14. When the cabin is pressurized, the air pressure also pushes the window assembly 12 against the window frame 14 to compress the seal 46.

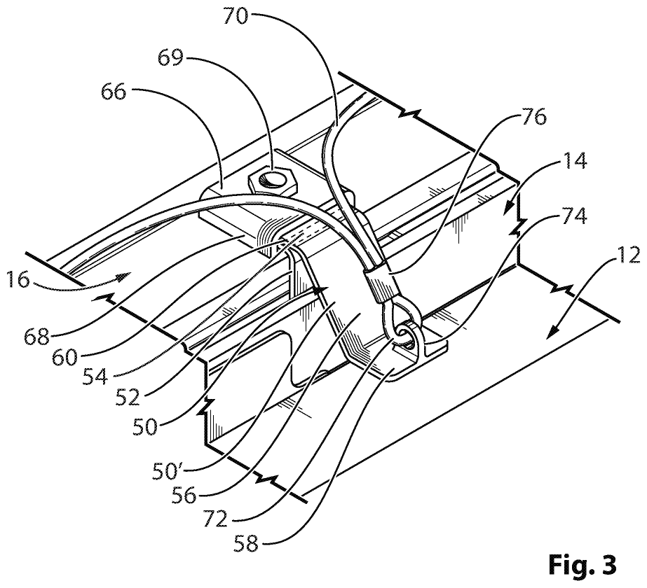

Referring to FIGS. 3-4, in the embodiment shown each retaining element 16 is defined as a clip generally including two members 50, 52 connected to one another. The first member 50 is engaged to (e.g. provides the bias against) the window assembly 12 and the second member 52 is connected to the window frame 14. Each retaining element 16 has a force-release portion so that the window assembly 12 can be disengaged from the window frame 14 through release of the force-release portion, as will be further detailed below. For example, at least the part 50′ of the first member 50 engaged to the window assembly 12 is detachable from the second member 52 upon application of a predetermined pulling force on the first member 50, thus disengaging the window assembly 12 from the second member 52.

In the embodiment shown, the first member 50 is more frangible than the second member 52 so that the window assembly 12 can be disengaged from the second members 52, and accordingly from the window frame 14, through breaking of the first members 50. More particularly, the force release portion includes a frangible portion 54 of the first member 50, defined between the part 50′ engaged to the window assembly 12 and the connection between the two members 50, 52; the frangible portion 54 is more frangible than a remainder of the first member 50, and more frangible than the second member 52, so that upon application of a pulling force on the first member 50, breaking of the retaining element 16 is directed to in or in proximity of the frangible portion 54.

In the embodiment shown, the first member 50 of each retaining element 16 includes a central planar body 56 and outer and inner flange 58, 60 each extending from a respective end of the body 56. The outer flange 58 is engaged to the window assembly 12. In the embodiment shown, the outer flange 58 is engaged to the window assembly 12 by being in contact with and compressing the seal 46 to apply pressure on the window assembly 12 against the inner surface 32 of the window frame 14. The window assembly 12 is thus retained by the spring load produced by the retaining elements 16. Alternately, a connection could be provided between the outer flange 58 and the window assembly 12. The inner flange 60 is located inwardly of the outer flange 58 and of the window frame 14, and is connected to the second member 52. The flanges 58, 60 extend non-perpendicularly from the body 56 and are not parallel to the body 56. In the embodiment shown, the flanges 58, 60 are parallel or substantially parallel to each other, and extend at an angle of approximately 45 degrees from the body 56, so that the first member 50 of the retaining element 16 has a “zigzag” shaped cross-section. Other configurations are of course possible.

In the embodiment shown, the second member 52 of the retaining element 16 includes a radial flange 62 and an inner flange 64 extending from an inner end of the radial flange 62. The radial flange 62 is connected to the radial portion 26 of the window frame 14, for example by suitable mechanical fasteners (e.g. rivets), and extends radially inwardly therefrom. The inner flange 64 abuts an outer surface of the inner flange 60 of the first member 50. The flanges 62, 64 of the second member 52 extend perpendicularly or substantially perpendicularly to one another, so that the second member 52 of the retaining element 16 has an “L” shaped cross-section. Other configurations are of course possible.

In the embodiment shown, the inner flanges 60, 64 of the first and second members 50, 52 are detachably interconnected by a clamped connection preventing relative motion between the first and second members 50, 52 at the connection. In the embodiment shown, the clamp connection is provided by a U-shaped clamping element 66 overlaying an inner surface of the inner flange 60 of the first member 50, and having side walls 68 (see FIG. 3) abutting and enclosing the sides of the overlaying inner flanges 60, 64 of the two members 50, 52. A bolt 69 extends through the clamping element 66 and inner flanges 60, 64. The side walls 68 of the clamping element 66 engaging the sides of the inner flanges 60, 64 limit or prevent relative rotation around the bolt connection 69.

In the embodiment shown, the frangible portion 54 of the first member 50 is defined in its inner flange 60, outside of but in proximity of the clamp element 66, such as to extend between the clamped connection and the body 56 of the first member 50. The frangible portion 54 is defined by a groove formed in the inner surface of the inner flange 60, across its width. The groove forms a fuse point or zone of reduced thickness with respect to a remainder of the retaining element 16, so as to direct breaking of the retaining element 16 upon application of the pulling force. It is understood that the frangible portion 54 can have any other suitable configuration including, but not limited to, perforation(s), V-groove(s), a difference in heat treatment between the frangible portion and the remainder of the retaining element 16. The clamp connection adjacent the frangible portion 54 provides for a controlled reaction point upon breaking of the retaining element 16.

In the embodiment shown and referring more particularly to FIG. 3, the emergency exit assembly 8 further includes a cable 70 (e.g. steel cable); the first member 50 of the retaining element 16 is also attached to the cable 70. The cable 70 forms a closed loop 72 at each of the retaining elements 16, and this closed loop 72 is engaged with a lug 74 extending inwardly from the outer flange 58 of the first member 50, for example attached integrally thereto. Each loop 72 is closed by a respective clamp 76, for example a barrel swage clamp, which interconnects two adjacent portions of the cable 70 folded against one another.

Referring back to FIG. 2, the cable 70 is serially connected to the retaining elements 16 around the perimeter of the window assembly 12: the cable extends from one retaining element 16 to the adjacent retaining element 16 around the perimeter, with the opposed end of the cable 70 connected to adjacent ones of the retaining elements 16. In the embodiment shown, a first end portion 70′ of the cable 70 is attached to a retaining element 16′ at the top of the window assembly 12, and the cable 70 then extends around the perimeter of the window assembly 12 in a clockwise direction, connected to each of the retaining elements 16 along the way, so that the opposed end 70″ of the cable 70 is connected to another retaining element 16″ at the top of the window assembly 12, located immediately next to and spaced in a counter-clockwise direction from the retaining element 16′ connected to the first end portion 70′ of the cable 70.

In the embodiment shown, the emergency exit assembly 8 further includes a first handle 78 attached to the first end portion 70′ of the cable 70 extending from that first retaining element 16′. The cable defines a plurality of intermediate cable portions 70′″ extending between adjacent ones of the retaining elements 16 and additional handles are each attached to one of the intermediate cable portions. In the embodiment shown, a second handle 80 is provided in an intermediate cable portion 70′″ located along a side of the window assembly 12, a third handle 82 is provided in an intermediate portion 70′″ located along the bottom of the window assembly 12, and a fourth handle 84 is provided in an intermediate portion 70′″ located along an opposed side of the window assembly 12. Each handle 78, 80, 82, 84 is for example defined by a loop of the cable 70 with a gripping member surrounding part of the cable 70 within the loop.

The handles 78, 80, 82, 84 can have any suitable configuration including, but not limited to, loops in the cable 70 closed by a suitable clip (e.g. crimped sleeve), metal handle engaged to the cable 70, carabiner clip engaged to the cable 70, etc.

Although in the embodiment shown the handles 78, 80, 82, 84 are attached to the same cable 70, it is understood that alternately, two or more separate cables could be provided, each attached to one or more of the handles 78, 80, 82, 84. For example, a first group of the intermediate cable portions 70′″ could be defined by a first cable connected to the first and second handles, and a second group of the intermediate cable portions 70′″ could be defined by a second cable connected to the third and fourth handles. Alternately, each of the handles 78, 80, 82, 84 could be attached to a respective cable. Alternate configurations are possible, providing each retaining element 16 is attached to at least one cable so that it can be broken when access to the emergency exit is required.

In a particular embodiment, the number of handles 78, 80, 82, 84 and their position is selected based on the available space in front of the window assembly 12 for the cable 70 to extend, so as to facilitate the application of the pulling force; the length of cable 70 between adjacent handles may be for example smaller than a distance between the window assembly 12 and the opposed cabin wall. Accordingly, the number and position of handles 78, 80, 82, 84 may be varied; in some embodiments, a single handle may be sufficient.

Still referring to FIG. 2, the window assembly 12 optionally includes a window handle 86 directly attached thereto to facilitate manipulation of the window assembly 12 once the retaining elements 16 are broken, as will be further detailed below. Alternately, more than one window handle may be provided.

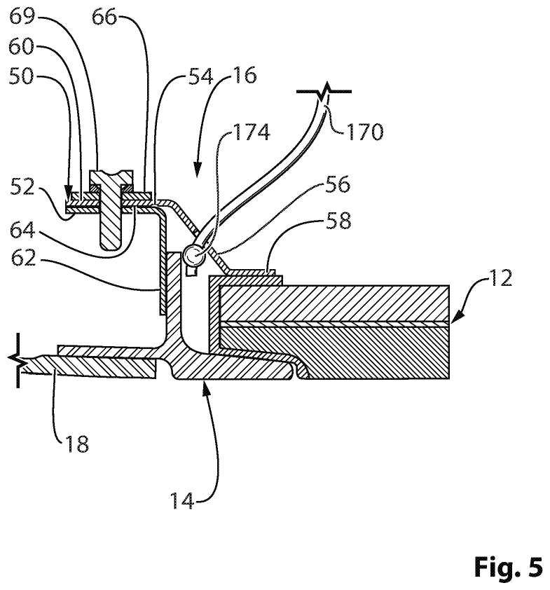

It is understood that the cable may be attached to the retaining elements 16 using any other suitable type of attachment. For example, in an alternate embodiment illustrated in FIG. 5, the cable 170 is threaded outwardly through an opening defined in the central body 56 of the first member 50, and a crimped ball 174 is engaged to the cable 170 outwardly of the central body 56 to prevent the cable 170 from being disengaged from the opening of the central body 56 when the pulling force is applied. The crimped ball 174 transfers the pulling force to the central body 56 so that the frangible portion 54 can be broken. The cable 170 may be configured similarly to the cable 70 shown in FIG. 2, with handles 78, 80, 82, 84.

In a particular embodiment, and referring to FIG. 4, the components particular to emergency exit system 8 are concealed during normal use of the aircraft. An interior wall panel 88 having an opening 90 aligned with a major part of the window assembly 12 to define the look of the window from the inside of the aircraft overlays the retaining elements 16, the cable 70 and the handles 78, 80, 82, 84 and hides them from view. The interior wall panel 88 is attached so as to be removable, preferably without the need to use any tools. In a particular embodiment, the emergency exit system 8 is provided in a lavatory of the aircraft.

In a particular embodiment, the emergency exit system 8 is particularly, although not exclusively, suitable for use by trained crew members, which have undergone prior training on the operation of the emergency exit system 8. For example, in use, when access to an emergency exit is required, the interior wall panel 88 is removed if present, and the retaining elements 16 are broken by pulling on the cable 70 to release the window assembly 12 from the window frame 14. The retaining elements 16 break along or near the frangible portions 54, so as to separate the portion of the first member 50 attached to the window assembly 12 from the second member 52 attached to the window frame 14.

In a particular embodiment, breaking of the retaining elements 16 is performed by pulling on the handles 78, 80, 82, 84 sequentially, i.e. one after the other following the direction of the cable 70 around the window assembly 12. Accordingly, the first handle 78 is pulled until all of the retaining elements 16 between the first and second handles 78, 80 are broken; this releases the second handle 80, which may remain attached to an unbroken retaining element 16. The second handle 80 is then pulled until all of the retaining elements 16 between the second and third handles 80, 82 are broken and the third handle 82 is released; the third handle 82 is then pulled until all of the retaining elements 16 between the third and fourth handles 82, 84 are broken and the fourth handle 84 is released; and the fourth handle 84 is pulled until the remaining retaining elements 16 are broken. However, this particular sequence is exemplary only. It is understood that any handle 78, 80, 82, 84 can be used to pull the cable 70 to break the retaining elements 16; for example, the first handle 78 can be pulled until some or all of the retaining elements 16 located between the second and third handles 80, 82 are broken.

Once the retaining elements 16 are broken, the window assembly 12 is displaced inwardly in the aircraft 1, for example by grabbing the window assembly 12 using the window handle(s) 86 directly attached thereto, if provided. The window opening 10 is now unobstructed, and can be used as an emergency exit. In a particular embodiment, breaking of the retaining elements 16 decompresses the seal 46 between the window assembly 12 and the window frame 14 without damaging this seal 46.

While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. For example, the first and second members of the retaining elements may be disengageable or disconnectable from one another through any other suitable configuration and through processes other than breaking; for example, the force release portion of the retaining elements may be defined by complementary shapes positively engaged by the pressure inside the cabin, but releasable upon application of a sufficient pulling force (e.g. ball-in-socket type of connection). Moreover, the pulling force required to release the window may be applied in any suitable way other than the cable(s) and handle(s) configuration shown and described.

Accordingly, the foregoing description is intended to be exemplary rather than limiting. The scope of the present invention is therefore intended to be limited solely by the scope of the appended claims.

1. An emergency exit assembly for an aircraft, the assembly comprising:
a window frame having spaced inner and outer surfaces interconnected by an edge surface, the edge surface surrounding a window opening;
a window assembly sealing the window opening and having an outer surface abutting the inner surface of the window frame around a perimeter of the window assembly; and
a plurality of retaining elements spaced around the perimeter of the window assembly, the retaining elements each connected to the window frame and biasing the window assembly toward and against the inner surface of the window frame, each retaining element including a frangible portion so that the window assembly can be disengaged from the window frame through breaking of the frangible portion.

2. The emergency exit assembly as defined in claim 1, wherein each of the retaining elements has first and second members connected to one another, the first member engaged to the window assembly and the second member connected to the window frame, the frangible portion being provided in the first member.

3. The emergency exit assembly as defined in claim 2, further comprising at least one cable connected to the first member of the retaining elements.

4. The emergency exit assembly as defined in claim 3, further comprising at least one handle attached to the at least one cable.

5. The emergency exit assembly as defined in claim 3, wherein the at least one cable is a single cable serially connected to the first member of the retaining elements.

6. The emergency exit assembly as defined in claim 3, wherein the at least one cable forms a plurality of closed loops each engaged in a lug of the first member of a respective one of the retaining elements.

7. The emergency exit assembly as defined in claim 2, wherein the first and second members are removably interconnected by a clamp preventing relative motion therebetween.

8. The emergency exit assembly as defined in claim 7, wherein the frangible portion is located in proximity of the clamp.

9. The emergency exit assembly as defined in claim 2, wherein the first member of each of the retaining elements includes an outer flange engaged to the window assembly, a planar body extending radially inwardly and toward the window frame, and an inner flange extending from the planar body and connected to the second member, the body extending non-perpendicularly to the inner and outer flanges.

10. The emergency exit assembly as defined in claim 9, wherein the second member includes a radial flange extending radially inwardly from the window frame and an additional inner flange extending perpendicularly to the radial flange and connected to the inner flange of the first member.

11. The emergency exit assembly as defined in claim 1, wherein the frangible portion comprises a groove of reduced thickness compared to a remainder of the retaining element.

12. The emergency exit assembly as defined in claim 1, further comprising a seal extending around an edge of the window assembly along an inner surface of the window assembly and between the window assembly and the window frame, the retaining elements engaging the window assembly through contact with and compression of the seal.

13. The emergency exit assembly as defined in claim 1, further comprising an end cable portion extending from a first one of the retaining elements, a plurality of intermediate cable portions each extending between a respective pair of adjacent ones of the retaining elements, a first handle connected to the end cable portion and at least one additional handle each attached to a respective one of the intermediate cable portions.

14. The emergency exit assembly as defined in claim 1, further comprising an interior wall panel overlaying the plurality of retaining elements so as to hide the plurality of retaining elements from view, the interior wall panel having an opening aligned with a major part of the window assembly, the interior wall panel being removable.

15. An emergency exit assembly for an aircraft, the assembly comprising:
a window frame having spaced inner and outer surfaces interconnected by an edge surface, the edge surface surrounding a window opening;
a window assembly sealing the window opening and having an outer surface abutting the inner surface of the window frame around a perimeter of the window assembly; and
a plurality of retaining elements spaced around the perimeter of the window assembly, each of the retaining elements engaged to the window assembly and connected to the window frame, the retaining elements biasing the window assembly toward and against the inner surface of the window frame, each of the retaining elements having a force-release portion so that the window assembly can be disengaged from the window frame through release of the force-release portion;
wherein upon application of a predetermined pulling force on the force release portion, at least a portion of the retaining element engaged to the window assembly is detachable from the window frame.

16. The emergency exit assembly of claim 15, wherein each of the retaining elements has first and second members connected to one another, the first member engaged to the window assembly and the second member connected to the window frame, the force release portion including a frangible portion intermediate the window assembly and a connection of the first member with the second member, the frangible portion being breakable upon application of the predetermined pulling force on the first member.

17. The emergency exit assembly as defined in claim 15, further comprising a seal extending around an edge of the window assembly along an inner surface of the window assembly and between the window assembly and the window frame, the retaining elements engaging the window assembly through contact with and compression of the seal.

18. The emergency exit assembly as defined in claim 15, further comprising a cable serially connected to the retaining elements for application of the pulling force.

19. The emergency exit assembly as defined in claim 18, wherein the at least one cable includes an end cable portion extending from a first one of the retaining elements and a plurality of intermediate cable portions each extending between a respective pair of adjacent ones of the retaining elements, the assembly further comprising a first handle connected to the end cable portion and at least one additional handle each attached to a respective one of the intermediate cable portions.

20. The emergency exit assembly as defined in claim 15, wherein each of the retaining elements includes an outer flange engaged to the window assembly, a planar body extending radially inwardly and toward the window frame, and an inner flange extending from the planar body and connected to a member connected to the window frame, the body extending non-perpendicularly to the inner and outer flanges.

21. The emergency exit assembly as defined in claim 20, wherein the inner flange is a first inner flange, the member including a radial flange extending radially inwardly from the window frame and a second inner flange extending perpendicularly to the radial flange and connected to the first inner flange.

22. A method of accessing an emergency exit of an aircraft, the method comprising:
breaking a plurality of retaining elements biasing a window assembly against an inner surface of a window frame, wherein breaking the retaining elements is performed by pulling at least one cable attached to the retaining elements; and
displacing the window assembly inwardly in the aircraft to access a window opening previously obstructed by the window assembly, the window opening defining the emergency exit.

23. The method as defined in claim 22, wherein pulling on the last least one cable includes sequentially pulling a plurality handles attached to a same cable, the handles spaced apart around a perimeter of the window assembly.

24. The method as defined in claim 22, further comprising, before pulling the at least one cable, removing an interior wall panel overlaying the retaining elements and the at least one handle to expose the at least one handle.
